(19) United States
(12) Patent Application Publication
(10) Pub. No.: US 2025/0219500 A1
(43) Pub. Date: Jul. 3, 2025

(54) SEALING SYSTEM FOR PERMANENT MAGNET MOTOR/GENERATOR

(71) Applicant: NUOVO PIGNONE TECNOLOGIE -S.R.L., Florence (IT)

(72) Inventors: Massimiliano ORTIZ NERI, Florence (IT); Matteo DOZZINI, Florence (IT); Francesco CANGIOLI, Florence (IT)

(21) Appl. No.: 18/867,253

(22) PCT Filed: May 23, 2023
(86) PCT No.: PCT/EP2023/025238

§ 371 Date: Nov. 19, 2024

(30) Foreign Application Priority Data
May 24, 2022 (IT) 102022000010703

(51) Int. Cl. H02K 7/00; H02K 5/20; H02K 7/09

(52) U.S. Cl. CPC H02K 7/003; H02K 5/20; H02K 7/09

(57) ABSTRACT

An electric machine comprising a rotary magnetic assembly, preferably comprising permanent magnets; a stationary magnetic assembly, preferably comprising electromagnets; a rotary hub having a cylindrical shape and a tube-shaped recess for housing the rotary magnetic assembly; a sleeve positioned around the tube-shaped recess so to surround it, and mechanically coupled to the rotary hub. The sleeve has a first end region and a second end region which are sealed to the rotary hub so to fluidly isolate the tube-shaped recess. The rotary hub comprises at least one inner channel which is fluidly coupled to the tube-shaped recess.

### TECHNICAL FIELD

The subject-matter disclosed herein relates to a sealing system for permanent magnet motor/generator. More particularly, the subject-matter disclosed herein relates to a sealing system for permanent magnet motor/generator which allows to use e.g. hydrogen as cooling fluid.

### BACKGROUND ART

Typically, a rotating electric machine is an energy converter which may convert electrical energy to mechanical energy (i.e. when the electric machine works as a motor) or may convert mechanical energy to electrical energy (i.e. when the electric machine works as a generator). Various types of electric machines may include permanent magnets. For example, conventional brushless motors comprise permanent magnets, fitted in a rotor of the electric machine, which have an air gap distance from a stator of the electric machine and which establish a magnetic field.

It is to be noted that a permanent magnet, if kept and used in optimal working conditions, which may include not subjecting the magnet to high temperatures (in particular above its maximum operating temperature) and protecting it from corrosion, will keep its magnetism for years. For this reasons, electric machines have to be properly cooled and protected from contact with aggressive fluids, which could degrade its materials, such as its permanent magnets. However, if the electric machine is coupled with a turbomachine, for example a compressor or an expander which process a fluid (i.e. compresses or expands a fluid), the electric machine has to be fluidly isolated from the process fluid as it could be dangerous for electric machine materials. This is typically carried out by equipping the electric machine with dry gas seals, which allow to isolate the electric machine from processed gas, for example a processed gas of a compressor and/or a expander coupled to the electric machine, and/or by cooling the electric machine and its parts, in particular its rotary magnetic assembly and its stationary magnetic assembly, with a cooling fluid, typically air.

However, adequately equipping the electric machine with components suitable to ensure the correct operation and maintenance of its parts is in contrast with the desire to have a compact electric machine.

### SUMMARY

It would be desirable to have an electric machine which is properly cooled and which has its rotary magnetic assembly and its stationary magnetic assembly preserved from degradation.

According to an aspect, the subject-matter disclosed herein relates to an electric machine which comprises a rotary magnetic assembly, a stationary magnetic assembly, a cylindrical rotary hub having a tube-shaped recess for housing the rotary magnetic assembly, and a sleeve positioned around the tube-shaped recess so to surround it. The sleeve is mechanically coupled to the rotary hub and has a first end region and a second end region sealed to the rotary hub so to fluidly isolate the tube-shaped recess. The rotary hub comprises at least one inner channel which is fluidly coupled to the tube-shaped recess.

According to another aspect, the subject-matter disclosed herein relates to a machine comprising an electric machine having a first shaft, which comprises a fluidly isolated rotary magnetic assembly, and a compressor and/or expander having a second shaft, the first shaft and the second shaft being mechanically coupled.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a simplified partial cross-sectional view of an embodiment of an electric machine with a sleeve to seal the rotary magnetic assembly,

FIG. 2 shows a simplified partial cross-sectional view of another embodiment of an electric machine with a sleeve to seal the rotary magnetic assembly having a rotary hub connected by a tie-rod,

FIG. 3 shows a simplified partial cross-sectional view of another embodiment of an electric machine with a sleeve to seal the rotary magnetic assembly having a different geometry,

FIG. 4 shows a simplified cross-sectional view of another embodiment of an electric machine with a sleeve to seal the rotary magnetic assembly having a double sealing assembly, and

FIG. 5 shows a simplified cross-sectional view of a machine comprising an electric machine according to any of FIGS. 1-4.

### DETAILED DESCRIPTION OF EMBODIMENTS

According to an aspect, the subject-matter disclosed herein relates to an electric machine which is preferably coupled to a turbomachine, for example a compressor or an expander, which uses in particular hydrogen both as process fluid of the turbomachine and as cooling fluid for the electric machine. The electric machine has rotary hub with a recess, typically a tube-shaped recess located on the external surface of the rotary hub, which houses a rotor assembly, typically permanent magnets of the rotor assembly. The electric machine has further a stator assembly, typically comprising electromagnets, which surrounds the rotor assembly and defines a first passage between the stator assembly itself and the rotor assembly, the first passage being adapted for flowing a cooling fluid of the electric machine. In order to protect the permanent magnets of the rotor assembly, the electric machine comprises further a sleeve which is sealed to the rotary hub so to fluidly isolate the tube-shaped recess which houses the permanent magnets. In order to stabilizing the permanent magnets, the rotary hub comprises at least one inner channel which is fluidly coupled to the tube-shaped recess and which may advantageously be configured to fill the tube-shaped recess with a suitable filling and possibly to be filled with a suitable filling.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

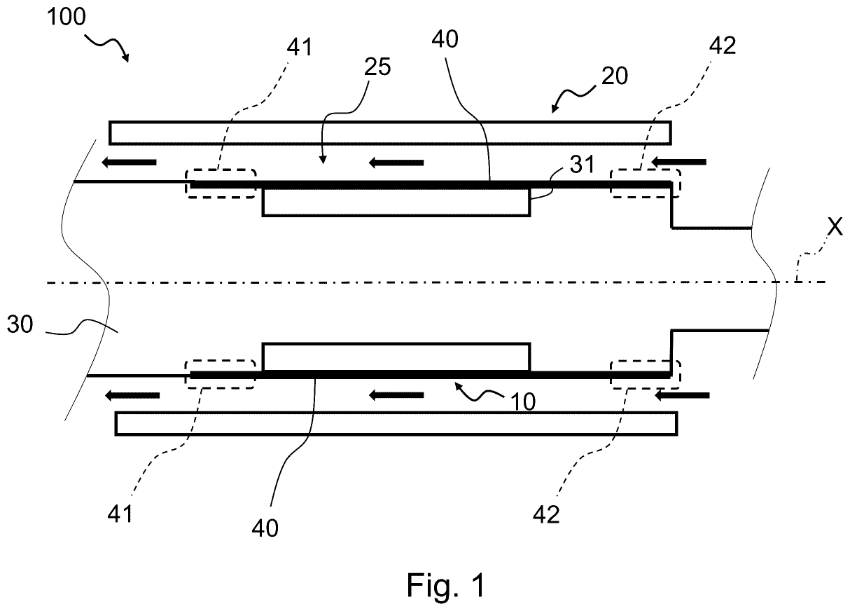

In FIG. 1 there is shown a (partial) simplified cross-sectional view of an embodiment of an electric machine with a sleeve configured to seal a rotary magnetic assembly, the electric machine being generally indicated with reference numeral 100. The electric machine 100 comprises a rotary magnetic assembly 10 (only very schematically shown in FIG. 1), a stationary magnetic assembly 20 (only very schematically shown in FIG. 1) and a rotary hub 30 having a cylindrical shape. Advantageously, the rotary hub 30 is part of a shaft of the electric machine 100 which determines an axis X. As it will be apparent from the following, the rotary hub 30 is configured to house the rotary magnetic assembly 10, and the stationary magnetic assembly 20 is arranged around the rotary hub 30, more specifically around a portion of the rotary hub 30.

It is to be noted that the electric machine 100 may be configured as an electric motor or an electric generator or may be configured both as an electric motor and an electric generator: for example, the electric machine 100 may be started as an electric motor and later, in particular when the mechanical torque exceeds the electric torque, may be switched as an electric generator.

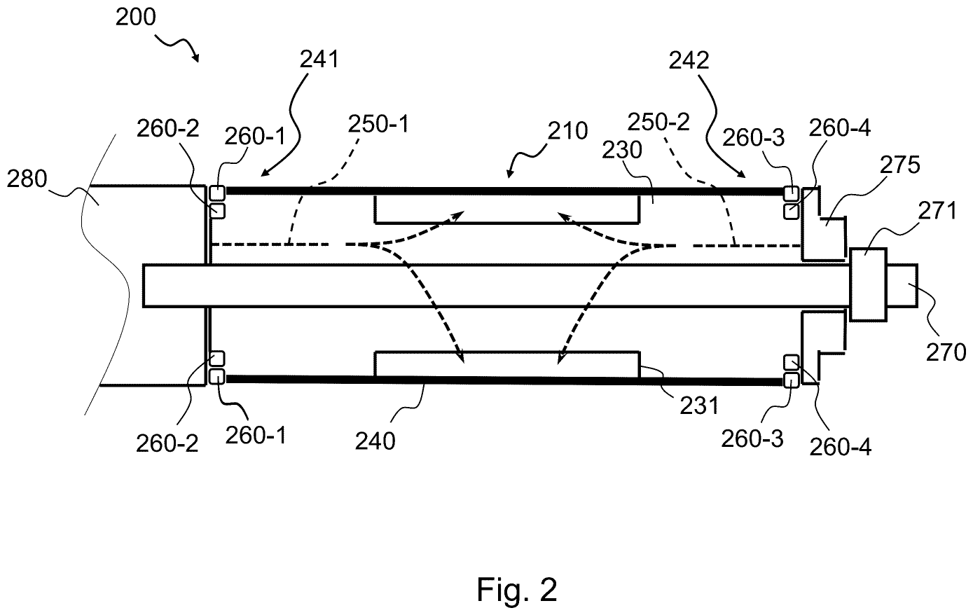

With non-limiting reference to FIG. 1, the rotary hub 30 has a tube-shaped recess 31, in particular in the form of a groove on a lateral surface of the rotary hub 30, for housing the rotary magnetic assembly 10. According to preferred embodiments, the rotary magnetic assembly 10 comprises permanent magnets. As it will be better described with non-limiting reference to FIGS. 2-4, the rotary hub 30 comprises at least one inner channel (not shown in FIG. 1) which is fluidly coupled to the tube-shaped recess 31 and which may advantageously be configured to fill the tube-shaped recess 31 with a suitable filling and possibly to be filled with a suitable filling, in particular to stabilize the permanent magnets housed in the tube-shaped recess 31. As it will be apparent from the following, the stationary magnetic assembly 20 is arranged to surround the rotary magnetic assembly 10. According to preferred embodiments, the stationary magnetic assembly 20 comprises electromagnets.

With non-limiting reference to FIG. 1, the electric machine 100 comprises further a sleeve 40 mechanically coupled to the rotary hub 30 and positioned around the tube-shaped recess 31 so to surround it, in particular to surround it completely. As shown in FIG. 1, the sleeve 40 has a first end region 41 and a second end region 42 which extend beyond the tube-shaped recess 31 and which are sealed to the rotary hub 30 so to fluidly isolate the tube-shaped recess 31.

As already mentioned, the stationary magnetic assembly 20 is arranged to surround the rotary magnetic assembly 10, in particular it surrounds the sleeve 40, so that an outer surface of the sleeve 40 and an inner surface of the stationary magnetic assembly 20 are facing each other. It is to be noted that the stationary magnetic assembly 20 and the rotary magnetic assembly 10 are radially spaced, so that there is a radial gap between them. It is to be noted that the radial gap between the stationary magnetic assembly 20 and the rotary magnetic assembly 10 may change from point to point and may vary based on distinct cross sections of the electric machine 100, due to for example the presence or absence of the electromagnets; in other words, the shape of the space between the outer surface of the sleeve and the inner surface of the magnetic assembly may be roughly cylindrical but not exactly cylindrical.

The electric machine 100 further comprises a cooling system, in particular to circulate a cooling fluid to cool the electric machine 100 (see for example the black arrows in FIG. 1). The cooling system comprises a first passage 25 at least partially defined between an outer surface of the sleeve 40 and an inner surface of the stationary magnetic assembly 20. According to a first approximation, the first passage 25 may be considered as a cylindrical passage which in a cross-section determines an approximally circular crown around the X axis; such crown may vary along the longitudinal direction. Advantageously, the first passage 25 is arranged to flow a cooling fluid, which preferably consists of or comprises hydrogen. According to different embodiments, the cooling fluid may consist of or comprise for example CO2, preferably in supercritical conditions, or helium.

Advantageously the sleeve 40 is made of or comprises a nickel-chromium-based superalloy or carbon fibers, in particular to protect the permanent magnets of the rotary magnetic assembly 10 from the cooling fluid, for example preventing the penetration of the cooling fluid in the tube-shaped recess 31, in particular of hydrogen.

FIG. 1 shows a first embodiment of an electric machine 100 in which only the first end region 41 or only the second end region 42 or both the first end region 41 and the second end region 42 of the sleeve 40 are welded to the rotary hub 30. According to a possibility, the sleeve 40 may be firstly heated up to around 300° C., in particular to expand it, then positioned around the tube-shaped recess 31, for example by sliding the sleeve 40 along the direction of the axis X until it surrounds the tube-shaped recess 31 and then the sleeve 40 is cooled, in particular to shrink it; finally, the sleeve 40 is welded to the rotor hub 30.

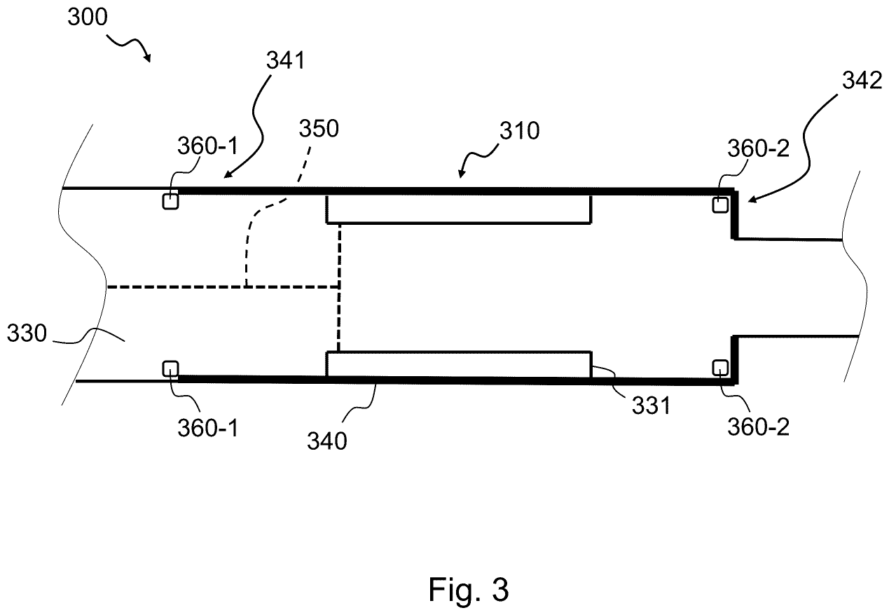

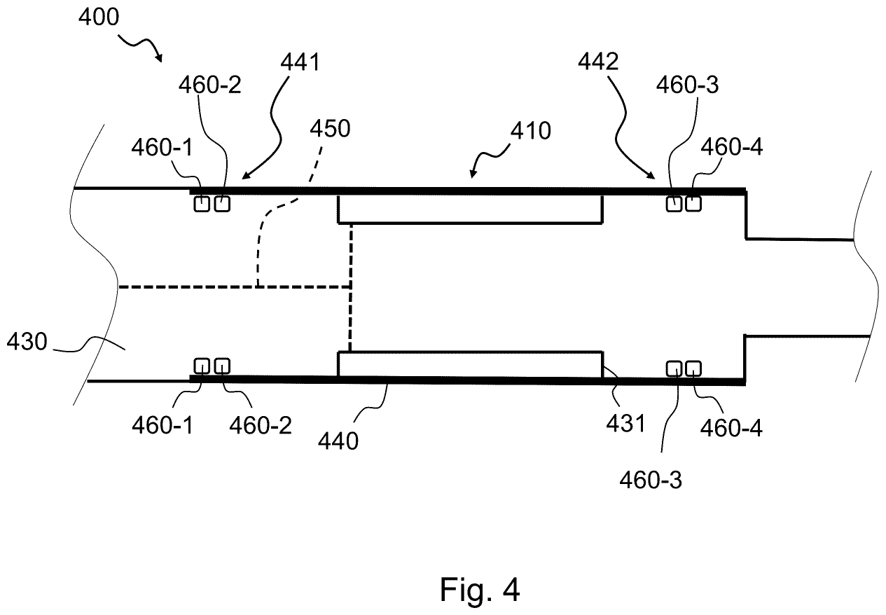

FIGS. 2-4 show various embodiments of sealing coupling between the sleeve and the rotary hub which in particular comprises at least one seal assembly 260 or 360 or 460, preferably two seal assemblies, mechanically coupled to the first end region and/or the second end region of the sleeve, as it will better explained in the following. Please note that, for example with reference to FIG. 2, the expression “seal assembly 260” is generally used for any of the seal assemblies 260-1, 260-2, 260-3 and 260-4. Similarly, with reference to FIG. 3, the expression “seal assembly 360” is generally used for any of the seal assemblies 360-1 and 360-2 and, with reference to FIG. 4, the expression “seal assembly 460” is generally used for any of the seal assemblies 460-1, 460-2, 460-3 and 460-4. The seal assembly 260 or 360 or 460 may comprise for example a C-ring seal, a spring energized C-ring seal, a cup seal or an O-ring seal, for example made of metal or a synthetic polymer (in particular polytetrafluoroethylene also known as “PTFE”). For the sake of clarity, it is to be noted that the stator assembly is not shown in FIGS. 2-4.

A second embodiment 200 of an electric machine will be described in the following with the aid of FIG. 2. It is to be noted that elements 210, 230, 231, 240, 241 and 242 in FIG. 2 may be identical or similar respectively to elements 10 (rotary magnetic assembly), 30 (rotary hub), 31 (tube-shaped recess), 40 (sleeve), 41 (first end region) and 42 (second end region) in FIG. 1 and perform the same or similar functions.

According to the embodiment of FIG. 2, the rotary hub 230 of the electric machine 200 is mechanically coupled to a shaft 280, for example a shaft of the electric machine 200. For example, the rotary hub 230 may be coupled to the shaft 280 by a tie rod 270 which passes through the rotor hub 230. The tie rod 270 may be used to press a first side of the rotor hub 230 against the shaft 280 and a flange 275 against a second side of the rotor hub 230. In particular, the tie rod 270 is mechanically coupled to the rotor hub 230 by a nut 271 which fixes the tie rod 270 to the rotor hub 230.

The electric machine 200 of FIG. 2 comprises two seal assemblies 260-1 and 260-2 which are mechanically coupled to the first end region 241 of the sleeve 240 and two seal assemblies 260-3 and 260-4 which are mechanically coupled to the second end region 242 of the sleeve 240. In particular, the electric machine 200 has an inner seal assembly 260-2 and an outer seal assembly 260-1 at the first end region 241 of the sleeve 240 and an inner seal assembly 260-4 and an outer seal assembly 260-3 at the second end region 242 of the sleeve 240. Advantageously, the seal assemblies 260-1 and 260-2 may prevent leakage of cooling fluid from a possibly gap between the shaft 280 and the rotor hub 230 and the seal assemblies 260-3 and 260-4 may prevent leakage of cooling fluid from a possibly gap between the flange 275 and the rotor hub 230.

Advantageously, the electric machine 200 further comprises at least an inner channel 250 which is fluidly coupled to the tube-shaped recess 231. According to the embodiment of FIG. 2, the electric machine 200 comprises a first channel 250-1 which fluidly couples the first side of the rotor hub 230 with the tube-shaped recess 231 and preferably a second channel 250-2 which fluidly couples the second side of the rotor hub 230 with the tube-shaped recess 231 (see the dashed lines in FIG. 2). In particular, the inner channels 250-1 and 250-2 are configured to fill the tube-shaped recess 231 with epoxy molding compound or synthetic oil and possibly to be filled with epoxy molding compound or synthetic oil. Advantageously, epoxy molding compound or synthetic oil may fill any possible gap between the rotor assembly 210 and the tube-shaped recess 231. Alternatively, the tube-shaped recess 231 and possibly also the inner channels 250-1 and 250-2 may be filled with aluminum oxide (known also as “alumina”) or a compound comprising aluminum oxide, for example nickel aluminate.

A third embodiment 300 of an electric machine will be described in the following with the aid of FIG. 3. It is to be noted that elements 310, 330, 331, 340, 341 and 342 in FIG. 3 may be identical or similar respectively to elements 10 (rotary magnetic assembly), 30 (rotary hub), 31 (tube-shaped recess), 40 (sleeve), 41 (first end region) and 42 (second end region) in FIG. 1 and perform the same or similar functions.

According to the embodiment of FIG. 3, the rotary hub 330 of the electric machine 300 has different cross sections, in particular a first larger cross section and a second smaller cross section, and defines a wall at the change section between the first cross section and the second cross section. Advantageously, the sleeve 340 is configured to surround both the tube-shaped recess 331 and the wall. In other words, the second end region 342 of the sleeve 340 is configured to cover at least partially the wall of the rotor hub 330.

The electric machine 300 of FIG. 3 comprises a first seal assembly 360-1 mechanically coupled to the first end region 341 of the sleeve 340 and a second seal assembly 360-2 mechanically coupled to the second end region 342 of the sleeve 340. According to a possibility, the sleeve 340 may be firstly heated up to around 300° C., in particular to expand it, then positioned around the tube-shaped recess 331, for example by sliding the sleeve 340 along the direction of the axis X until it surrounds the tube-shaped recess 331 and the second end region 342 abut against the wall of the rotor hub 330. Then, a weight may be placed on the sleeve 340 so that at least the second seal assembly 360-2 is compressed by the weight; finally, the sleeve 340 is cooled, in particular to shrink it, and the weight may be removed, so that at least the second seal assembly 360-2 is maintained compressed by the sleeve 340.

Advantageously, the electric machine 300 further comprises at least an inner channel 350 which is fluidly coupled to the tube-shaped recess 331 and which is configured to fill the tube-shaped recess 231 with epoxy molding compound or synthetic oil and possibly to be filled with epoxy molding compound or synthetic oil (see the dashed line in FIG. 3). Advantageously, epoxy molding compound or synthetic oil may fill any possible gap between the rotor assembly 310 and the tube-shaped recess 331. Alternatively, the tube-shaped recess 331 and possibly also the inner channel 350 may be filled with aluminum oxide (known also as “alumina”) or a compound comprising aluminum oxide, for example nickel aluminate.

A fourth embodiment 400 of an electric machine will be described in the following with the aid of FIG. 4. It is to be noted that elements 410, 430, 431, 440, 441 and 442 in FIG. 4 may be identical or similar respectively to elements 10 (rotary magnetic assembly), 30 (rotary hub), 31 (tube-shaped recess), 40 (sleeve), 41 (first end region) and 42 (second end region) in FIG. 1 and perform the same or similar functions.

According to the embodiment of FIG. 4, the electric machine 400 comprises two seal assemblies 460-1 and 460-2 which are mechanically coupled to the first end region 441 of the sleeve 440 and two seal assemblies 460-3 and 460-4 which are mechanically coupled to the second end region 442 of the sleeve 440. In particular, both the seal assemblies 460-1 and 460-2 and the seal assemblies 460-3 and 460-4 are adjacent one to another along axial direction.

Advantageously, the electric machine 400 further comprises at least an inner channel 450 which is fluidly coupled to the tube-shaped recess 431 and which is configured to fill the tube-shaped recess 231 with epoxy molding compound or synthetic oil and possibly to be filled with epoxy molding compound or synthetic oil (see the dashed line in FIG. 4). Advantageously, epoxy molding compound or synthetic oil may fill any possible gap between the rotor assembly 410 and the tube-shaped recess 431. Alternatively, the tube-shaped recess 431 and possibly also the inner channel 450 may be filled with aluminum oxide (known also as “alumina”) or a compound comprising aluminum oxide, for example nickel aluminate.

According to another possibility not shown in the figures, the embodiments described above, in particular of the sealing of the sleeve to the rotary hub, could be combined with each other: for example, the sleeve may have a first end region which is welded to the rotary hub and a second end region which comprises a seal assembly mechanically coupled to the rotary hub.

According to another aspect, the subject-matter disclosed herein relates to a machine comprising:
an electric machine which comprises a rotary magnetic assembly, a stationary magnetic assembly, a rotary hub having a tube-shaped recess for housing the rotary magnetic assembly and a sleeve positioned around the tube-shaped recess so to surround it and having a first end region and a second end region sealed to the rotary hub so to fluidly isolate the tube-shaped recess, where the rotary hub comprises at least one inner channel which is fluidly coupled to the tube-shaped recess and which may advantageously be configured to fill the tube-shaped recess with a suitable filling and possibly to be filled with a suitable filling, and
a compressor and/or expander,
   the electric machine having a first shaft and the compressor and/or expander having a second shaft, the first shaft and the second shaft being mechanically coupled.

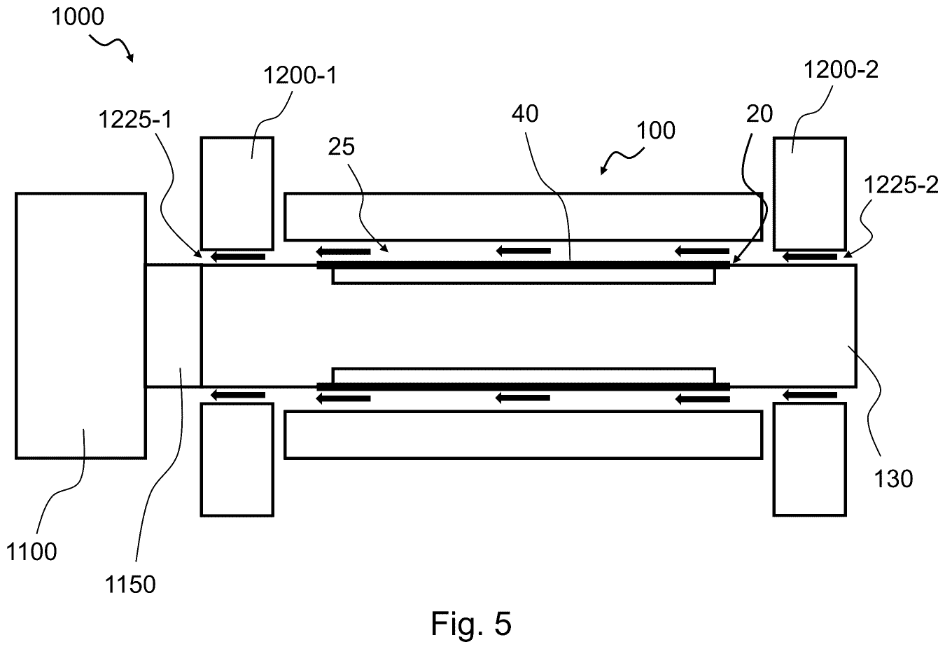

With non-limiting reference to FIG. 5, it is shown very schematically a machine, generally indicated with reference 1000, comprising an electric machine 100 having a first shaft 130 and at least one mechanic machine 1100 (for example a compressor or an expander) having a second shaft 1150 mechanically coupled to the first shaft 130, for example the second shaft 1150 is welded to the first shaft 130; by the way, both shafts might also be realized in a single piece. In the embodiment of FIG. 5, there is only one mechanic machine located at a side of the electric machine; according to a first alternative, there may be, for example, at least one first electric machine located at a first side of the electric machine and at least one second electric machine located at a second side of the electric machine; according to a second alternative, there may be, for example, two or more mechanic machines located at one or both sides of the electric machine.

Advantageously the machine 1000 further comprises a cooling system configured to circulate a cooling fluid for cooling at least the electric machine 100. In particular, the cooling system comprises a first passage 25 for flowing the cooling fluid which is at least partially defined between an outer surface of the sleeve 40 and an inner surface of the stationary magnetic assembly 20 of the electric machine 100. According to a preferred embodiment, the cooling fluid is a process fluid processed by the compressor and/or the expander 1100. For example, the cooling fluid consists of or comprises hydrogen.

With non-limiting reference to FIG. 5, the machine 1000 may further comprise at least a magnetic bearing 1200, advantageously two magnetic bearings 1200-1 and 1200-2, a first magnetic bearing 1200-1 being arranged at a first end of the electric machine 100, in particular between the first end of the electric machine 100 and the compressor and/or the expander 1100, and a second magnetic bearing 1200-2 being arranged at a second end of the electric machine 100. In particular, the cooling circuit comprises a second passage 1225 for flowing the cooling fluid which is at least partially defined between an outer surface of the first shaft 130 and/or the second shaft 1150 and an inner surface of the magnetic bearing(s) 1200-1 and 1200-2. According to a preferred embodiment, the second passage(s) 1225-1 and 1225-2 is fluidly coupled to the first passage 25. In other words, the cooling fluid which flows in the first passage 25 is the same cooling fluid which flows in the second passage 1225. For example, the cooling fluid may initially flow into the second passage 1225-2 for cooling the magnetic bearing 1200-2, then flow into the first passage 25 for cooling the electric machine 100 and finally flow into the second passage 1225-1 for cooling the magnetic bearing 1200-1.

1. An electric machine comprising:
a rotary magnetic assembly,
a stationary magnetic assembly,
a rotary hub having a cylindrical shape and a tube-shaped recess for housing the rotary magnetic assembly, and
a sleeve positioned around the tube-shaped recess so to surround it, and mechanically coupled to the rotary hub,
wherein the sleeve has a first end region and a second end region, the first end region and the second end region being sealed to the rotary hub so to fluidly isolate the tube-shaped recess,
wherein the rotary hub comprises at least one inner channel, and
wherein the inner channel is fluidly coupled to the tube-shaped recess.

2. The electric machine of claim 1, further comprising a cooling system,
wherein the stationary magnetic assembly surrounds the sleeve,
wherein the cooling system comprises a first passage for flowing a cooling fluid, and
wherein the first passage is at least partially defined between an outer surface of the sleeve and an inner surface of the stationary magnetic assembly.

3. The electric machine of claim 2, wherein the cooling fluid consists of or comprises hydrogen.

4. The electric machine of claim 1, wherein the sleeve is made of or comprises a nickel-chromium-based superalloy or carbon fibers.

5. The electric machine of claim 1, wherein the first end region and/or the second end region of the sleeve are welded to the rotary hub.

6. The electric machine of claim 1, further comprising at least one seal assembly,
wherein the seal assembly is mechanically coupled to the first end region or the second end region of the sleeve.

7. The electric machine of claim 1, further comprising at least a first seal assembly and a second seal assembly,
wherein the first seal assembly is mechanically coupled to the first end region, and
wherein the second seal assembly is mechanically coupled to the second end region.

8. The electric machine of claim 1, wherein the inner channel is configured to fill the tube-shaped recess with epoxy molding compound or synthetic oil and possibly to be filled with epoxy molding compound or synthetic oil.

9. The electric machine of claim 1, wherein the rotary hub is part of a shaft of the electric machine.

10. The electric machine of claim 1, being configured as an electric motor and/or an electric generator.

11. A machine comprising:
an electric machine according to claim 1 having a first shaft, and
a compressor and/or expander having a second shaft,
wherein the first shaft is mechanically coupled to the second shaft.

12. The machine of claim 11, further comprising a cooling system
wherein the stationary magnetic assembly surrounds the sleeve,
wherein the cooling system comprises a first passage, for flowing a cooling fluid,
wherein the first passage is at least partially defined between an outer surface of the sleeve and an inner surface of the stationary magnetic assembly, and
wherein the cooling fluid is a process fluid processed by the compressor and/or expander.

13. The machine of claim 12, further comprising at least one magnetic bearing,
wherein the magnetic bearing surrounds the first shaft or the second shaft,
wherein the cooling system comprises a second passage for flowing a cooling fluid,
wherein the second passage is at least partially defined between an outer surface of the first shaft or the second shaft and an inner surface of the magnetic bearing, and
wherein the second passage is fluidly couped to the first passage.
